(19) United States
(12) Patent Application Publication
(10) Pub. No.: US 2015/0129392 A1
(43) Pub. Date: May 14, 2015

(54) System to Measure Thickness of an Object

(71) Applicant: SENSIBLE TECHNOLOGIES, L.L.C., Austin, TX (US)

(72) Inventor: Herbert S. Taylor, III, Livonia, MI (US)

(21) Appl. No.: 14/075,778

(22) Filed: Nov. 8, 2013

(51) Int. Cl. G01B 11/06; B65G 43/08

(52) U.S. Cl. CPC G01B 11/06; B65G 43/08
USPC 198/502.2; 356/630

(57) ABSTRACT

A system that measures a thickness of an object includes a conveyor to convey the object and an engagement member movable in response to the thickness of the object. The system further includes a lever connected to the engagement member, the lever movable with the movement of the engagement member, and a measurement device to measure the thickness of the object based on a measured position of the lever.

### BACKGROUND

In paper handling systems, it is often necessary or desirable to detect the sheet quantity of paper products to determine whether the correct number of sheets of paper are being handled or transported. For example, one particular system that is useful to detect the thickness of paper and sheet products is on envelope inserting machines that insert product such as advertisements, promotional materials, booklets, billing statements, or other material into host-product, such as envelopes, magazines, or newspapers.

In many cases, the insert product has intrinsic value, such as a credit card, a driver's license, and/or a promotional or discount coupon. In such a case, it is important that the envelope inserting machine insert only one such insert into the host-product. Further, even in cases where the insert product does not have much intrinsic value, it is important to insert only one of such product to each subscriber. For example, the insert product may have information particular to and/or confidential to each subscriber. If multiple insert products are inserted into a single host product, then subscribers will be sent insert products that have information for and of another subscriber.

Envelope inserting machines and other paper-handling systems have used sheet quantity detectors to detect the sheet quantity of the inserts or other paper. The individual inserts may be single sheet or multiple sheets. If more than the desired thickness (or number of inserts) is detected, corrective action usually needs to be taken to remove the excess. This increases the chance for human error in an insert operation that has deadlines in getting the fully-inserted product to its ultimate destination, such as a subscriber's home or newsstand.

Attempts to detect sheet quantity of inserts have included contact sensors, radiation sources and detectors, fiber optic light sensors, Hall sensor devices, and measuring the capacitance of the document. However, those attempts have met varying degrees of success, and some of them are affected by the temperature and humidity of the environment, as well as other process variables. As such, increasing the efficiency and reliability for these detectors remains a priority to avoid delays when operating envelope inserting machines and other paper-handling systems. Calibrating these legacy devices can also be complicated, time consuming, or problematic.

### BRIEF DESCRIPTION OF THE DRAWINGS

For a detailed description of the preferred embodiments of the invention, reference will now be made to the accompanying drawings in which:

FIGS. 1A, 1B, and 1C show schematic views of a system to measure a thickness of an object in accordance with one or more embodiments of the present disclosure; and

FIG. 2 shows a perspective view of a system to measure a thickness of an object in accordance with one or more embodiments of the present disclosure.

### DETAILED DESCRIPTION

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not structure or function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience, but does not require any particular orientation of the components.

Accordingly, disclosed is a system and assembly for measuring a thickness of an object, such as a sheet product that may be conveyed along a conveyor. A sheet product may refer to a product including one or more sheets, such as sheets of paper, plastic, and/or other material. For example, a sheet product may refer to a sheet including an attachment thereto, such as a sheet of paper including a plastic card attached thereto, in which the sheet may or may not be inserted into another sheet product, such as inserted within an envelope. As such, the present disclosure contemplates multiple arrangements and configurations of a sheet product. For example, a sheet product may include one or more sheets, attachments, and/or materials, in which a system and/or assembly in accordance with the present disclosure may be used to measure a thickness of the sheet product. Further, those having ordinary skill in the art will appreciate that, though the present disclosure specifically mentions a sheet product as an example of an object that may have a thickness measured, other objects may be used and have a thickness measured without departing from the scope of the disclosure.

As such, a system and assembly for measuring a thickness of an object may include a conveyor to convey the object and a lever movable in response to the thickness of the object. The lever may include an engagement member to engage an object as it passes the engagement member, the lever being movable with the movement of the engagement member. Further, a measurement device may be included to measure the thickness of the object. In particular, the measurement device may be used to measure movement of the lever, such as when engaged and when not engaged with the object, in which the measurement device may be able to measure the thickness of the object based on a measured movement of the lever.

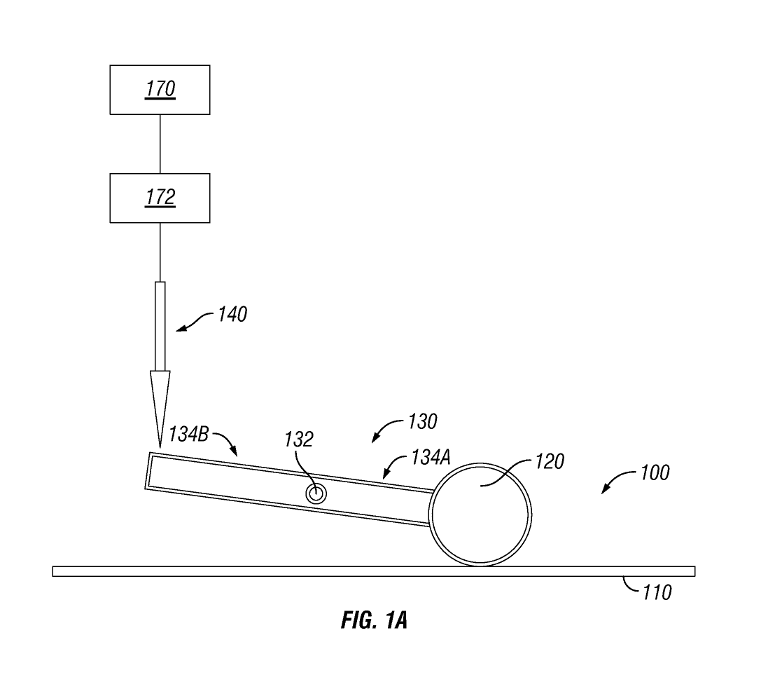

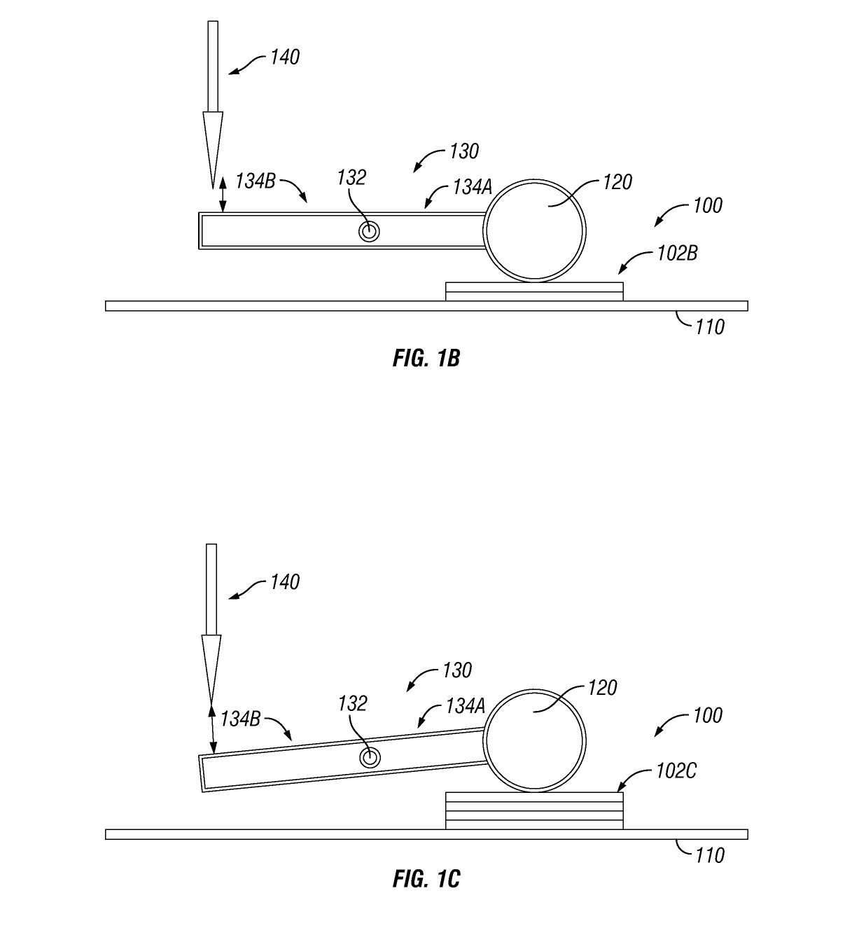

Referring now to FIGS. 1A, 1B, and 1C, multiple schematic views of a system 100 to measure a thickness of an object 102 in accordance with one or more embodiments of the present disclosure are shown. In particular, FIG. 1A shows a view of the system 100 when an object is not present for measurement, FIG. 1B shows a view of the system 100 when an object 102B is present to measure a thickness thereof, and FIG. 1C shows a view of the system 100 when an object 102C is present to measure a thickness thereof. As shown, the objects 102B and 102C may be sheet products in accordance with one or more embodiments of the present disclosure.

In addition to other elements and components, the system 100, as shown, may include a conveyor 110, an engagement member 120, a lever 130, and a measurement device 140. The conveyor 110 may be used to convey an object 102 into and out of engagement with the engagement member 120. As such, as an object 102 travels on the conveyor 110 and may be engaged and contacted by the engagement member 120, causing the engagement member 120 to move in response to the thickness of the object 102. When engaged with the engagement member 120, the object 102 may be positioned between the engagement member 120 and the conveyor 110, such as shown in FIGS. 1B and 1C. Otherwise, when no object is present, the engagement member 120 may return to a position against the conveyor 110, such as shown in FIG. 1A.

The lever 130 may be connected to the engagement member 120, in which the lever 130 may move in accordance with the movement of the engagement member 120. For example, as shown, the lever 130 may be rotatably connected to an axis 132, in which the lever 130 may rotate about the axis 132 in response to the movement of the engagement member 120.

The measurement device 140 may be used to measure the movement of the lever 130 and/or the engagement member 120. As such, the thickness of the object 102 may be measured based upon the measured movement or position of the lever 130 and/or the engagement member 120. For example, a comparison of the measured position of the lever 130 and/or the engagement member 120 when no object is present within the system 100 and the engagement member 120 is not in contact or engaged with an object, such as shown in FIG. 1A, with the measured position of the lever 130 and/or the engagement member 120 when an object 102 is present within the system 100 and the engagement member 120 is in contact or engaged with the object 102, such as shown in FIGS. 1B and 1C, may result in an output from the measurement device 140 that corresponds to and is based upon the thickness of the object 102.

As shown, the lever 130 may rotatably connected to the axis 132 to move and rotate about the axis 132 in response to the movement of the engagement member 120. As such, the axis 132 may be used to define an engagement side 134A and a free side 134B for the lever 130. In such an embodiment, the engagement member 120 may be connected to the engagement side 134A of the lever 130. Further, the measurement device 140 may be operably coupled to the free side 134B of the lever 130, in which the measurement device 140 may be used to measure the movement of the free side 134B of the lever 130 when measuring and determining a thickness of an object within the system 100.

As shown in FIGS. 1A, 1B, and 1C, the engagement member 120 may be connected to an end of the lever 130, such as the end of the lever 130 on the engagement side 134A, and the measurement device 140 may be operably to another end of the lever 130, such as the end of the lever 130 on the free side 134B. However, those having ordinary skill in the art will appreciate that the present disclosure is not so limited, as the engagement member and the measurement device may be connected and/or operably coupled to any location of the lever, such as by having the engagement member and the measurement device connected and/or operably coupled to the same side and/or same end of the lever without departing from the scope of the present disclosure.

As shown in FIG. 1A, when no object is present within the system 100, the engagement member 120 may be positioned against the conveyor 110, and as shown in FIGS. 1B and 1C, when an object 102 is present within the system 100, the object 102 may be positioned between the engagement member 120 and the conveyor 110. Accordingly, in one or more embodiments of the present disclosure, the engagement member 120 may be biased towards the conveyor 110. This configuration may facilitate having the engagement member 120 contact and engage the object 102 when present within the system 100, or having the engagement member 120 contact and engage the conveyor 110 when no object is present within the system 100.

As such, a biasing mechanism may be used to bias the engagement member 120 towards the conveyor. For example, in one or more embodiments, a biasing mechanism, such as a spring or other biasing mechanism known in the art, may be positioned about the axis 132 of the lever 130 to bias the lever 130, thereby biasing the engagement member 120 connected to the lever 130 towards the conveyor 110. One having ordinary skill in the art will appreciate, however, that other configurations and arrangement may be used to bias the engagement member towards the conveyor, such as by having a biasing mechanism coupled between the conveyor and the engagement member and/or lever to bias (e.g., “pull”) the engagement member towards the conveyor.

As shown in FIGS. 1A, 1B, and 1C, the engagement member 120 may include a roller, such as by having the roller rotatably connected to the lever 130. As such, as the object 102 enters into engagement with the engagement member 120, the roller may physically contact and engage the object 102, in which the roller may rotate about an axis that rotatably connects the roller to the lever 130. This connection between the roller and the lever 130 may facilitate the movement of the object 102 along the conveyor 110 when entering into the system 100 and contacting and engaging the roller. However, those having ordinary skill in the art will appreciate that the present disclosure is not so limited, as the engagement member in accordance with the present disclosure may be any type of engagement member know in the art that may contact and engage an object, which may or may not be rotatably connected to the lever within the system, without departing from the scope of the present disclosure.

In accordance with one or more embodiments of the present disclosure, a lever used within a system of the present disclosure may include one or more arms. For example, as shown in FIGS. 1A, 1B, and 1C, the lever 130 may include a single arm, such as by having the arm rotatably connected to the axis 132 with the engagement member 130 connected thereto. Those having ordinary skill in the art, however, will appreciate that the lever 130 may include more than one arm, such as by having a first arm connected to the axis 132, with a second arm and/or a third arm connected to one or both ends of the first arm. In such an embodiment, the engagement member 120 and the measurement device 140 may be connected and/or operably coupled to the first arm, second arm, or third arm without departing from the scope of the present disclosure.

Further, in accordance with one or more embodiments of the present disclosure, a measurement device used within a system of the present disclosure may include any measurement device known in the art. For example, the measurement device may include a mechanical, electrical, optical, and/or any other type of measurement device known in the art, in which the measurement device may be used to measure the movement and/or rotation of the lever and/or the engagement member as the lever and/or engagement member moves in response to the thickness of an object.

As discussed above, a system in accordance with the present disclosure may be used to measure a thickness of an object, such as the thickness of a sheet product. For example, in paper handling systems or other similar systems, it may be necessary or desirable to detect a thickness of an object, such as the thickness or sheet quantity within a sheet product to determine whether the correct number of sheets is included within the sheet product. As such, a system and/or assembly of the present disclosure may be used within such an embodiment.

In one or more embodiments, a system in accordance with the present disclosure may be used to not only measure a thickness of an object, but the system may also be used to determine if the object has too small or too large of a thickness for the purpose of the object. For example, if a sheet product has too many sheets or too few of sheets, when the system measures the thickness of the sheet product, the system may compare the measured thickness of the sheet product with a predetermined quantity and/or with the thickness of other sheet products that have been measured. If the thickness is greater or less than a given quantity or range, such as by comparing the measured thickness of the object with a certain tolerance (e.g., within 5% of a desired thickness), the system may be used to alert that the sheet product or object is too large or too small. This condition may allow the system to be stopped, in which the sheet product or object may be inspected to determine if the sheet product or object needs to be altered (e.g., add or remove particular sheets) for the desired purpose.

For example, in one or more embodiments, when the object 102B having a desired thickness is received into the system 100 and is measured, such as shown in FIG. 1B, the system 100 may allow the object 102B to be received into the system 100 on the conveyor 110 and then out through the system 100 using the conveyor 110. However, when the object 102C having an undesired thickness, such as being too thick or too thin, is received into the system 100 and is measured, such as shown in FIG. 1C, the system 100 may allow the object 102C to be received into the system 100 on the conveyor 100, but the system 100 may send an alert to prevent the object 102C from continuing to pass through the system 100 without being independently checked or verified.

As such, in one or more embodiments, a system in accordance with the present disclosure may include a programmable logic controller and/or an amplifier. For example, as shown in FIG. 1A, the measurement device 140, such as a fiber optic unit, may be included with and/or connected to an amplifier 172 and/or a programmable logic controller 170. The programmable logic controller 170 may be used to receive an output from the measurement device, in which the programmable logic controller may use the output from the measurement device to determine a thickness of an object based upon the measurements taken using the measurement device. Further, the amplifier 172 may be used to amplify a signal from the measurement device, such as by using an optical amplifier to amplify an optical signal. As such, a programmable logic controller and/or an amplifier may be used in accordance with one or more embodiments of the present disclosure to facilitate measuring a thickness of an object. In particular, a programmable logic controller and/or an amplifier may be used when sending, receiving, and/or controlling signals from multiple devices and components, such as signals produced, sent, received, and/or controlled by a measurement device in accordance with the present disclosure.

For example, the programmable logic controller may be used to determine the thickness of the object based upon the difference of the positions measured of the lever and/or the engagement member using the measurement device. The programmable logic controller may be used to determine if an object is too thick and/or too thin when measured for thickness, such as described above. Further, the system may be self-calibrating, such as by having the programmable logic controller automatically calibrate the system based upon an initial output from the measurement device received by the programmable logic controller when the system is originally activated or turned on. For example, in one or more embodiments, a calibration controller may be used to initiate a calibration process, such as when the engagement member is in a non-engaged position. After the calibration process has then been initiated and/or completed, movement of the engagement member away from the non-engaged position may be measured to correspond to a thickness of an object engaged by the engagement member.

Furthermore, the system may be used to have only certain intervals or “gates” when measuring the thickness of an object, and then ignoring the measurements provided by the system otherwise. For example, a programmable logic controller may be used to only receive and/or read an output from the measurement device when an object has been received into the system, thereby enabling the system to ignore other information that may be irrelevant and/or otherwise confuse the system.

Referring still to FIGS. 1A, 1B, and 1C, and as discussed above, the measurement device 140 may be used to measure the movement of the lever 130 and/or the engagement member 120. In an embodiment in which the measurement device 140 is measuring the movement of the lever 130, such as when the lever 130 moves with the engagement member 120 in response to the thickness of an object 102, the measurement device 140 may be distanced further from the axis 132 of the lever 130 than the engagement member 120. For example, the measurement device 140 may measure the free side 134B of the lever 130, in which the measurement device 140 may be further from the axis 132 of the lever 130 than the engagement member 120 on either the measurement side 134B and/or the engagement side 134A. By having the measurement device 140 further from the axis 132 than the engagement member 120, this arrangement or configuration enables the measured movement of the lever 130 to be amplified when the engagement member 120 moves in response to the thickness of an object 102. For example, in an embodiment in which the measurement device 140 is three times further from the axis 132 than the engagement member 120, the measured movement of the lever 130 may be three times movement of the engagement member 120 when moving in response to the thickness of an object 102. Such an arrangement or configuration may enable a system in accordance with the present disclosure to increase in accuracy when measuring a thickness of an object.

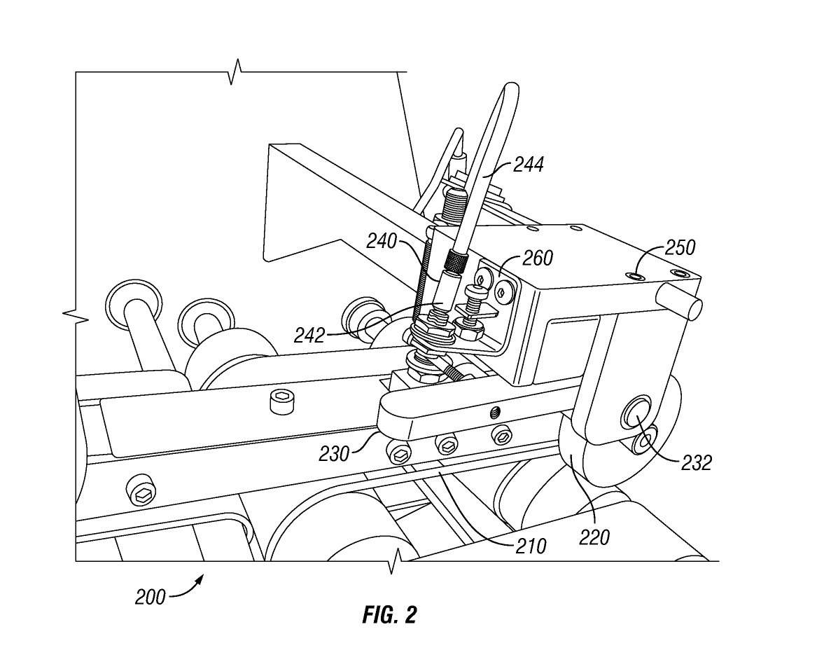

Referring now to FIG. 2, a perspective view of a system 200 for measuring a thickness of an object in accordance with one or more embodiments of the present disclosure is shown. As with the above, the system 200 may include a conveyor 210 that may convey the object and an engagement member 220 that may move in response to the thickness of the object. Further, the system 200 may further include a lever 230 that may be connected to and movable with the engagement member 220, such as rotatable about an axis 232, and may include a measurement device 240 that may measure the thickness of the object based on a measured movement of the lever 230.

Further, as shown, a measurement device support 250 may be used to mount the measurement device 240 for measuring the movement or position of the lever 230 and/or the engagement member 220. The measurement device support 250 may include one or more arms or brackets, such as to fix the measurement device 240 in a relative position within the system 200. As shown in FIG. 2, the measurement device support 250 may be connected between the measurement device 240 and the lever 230, such as the axis 232 of the lever 230.

Further, a deflection member 260 may be connected between the measurement device 240 and the lever 230 and/or the engagement member 220, such as by having the deflection member 260 connected between the measurement device 240 and the measurement device support 250. The deflection member 260 may be used to have the measurement device 240 deflect with respect to the measurement device support 250, the lever 230, and/or the engagement member 220. For example, as shown in FIG. 2, the deflection member 260 may include a screw that may be selectively rotated to deflect an arm of the deflection member 260 with respect to the other portions of the deflection member 260, thereby deflecting the measurement device 240 connected to the deflection member 260. As such, by including the deflection member 260, the measurement device 240 may be selectively deflected to have the measurement device 240 in a desired position for measuring the lever 230 and/or the engagement member 220.

As discussed above, in accordance with one or more embodiments, a fiber optic unit may be used as a measurement device 240. In use, the fiber optic unit may emit therefrom and receive therein a light source, such as a focused beam of light from a light-emitting diode (“LED”). In such an embodiment, the amount of light received within the fiber optic unit may be used to measure the distance of the movement of the lever, such as when measuring the thickness of the object 102 received within the system 100. In such an embodiment, the measurement device 240 may include a lens 242 and/or a lens kit with a fiber optic cable 244 operably coupled and connected to the lens 242. As such, a modulated light source may be emitted through the lens 242 and received back through the lens 242 and into the cable 244. In particular, in one embodiment, the light source may be sent out of an outer portion of the cable 244, with an inner portion of the cable 244 then receiving the light source.

Although the present invention has been described with respect to specific details, it is not intended that such details should be regarded as limitations on the scope of the invention, except to the extent that they are included in the accompanying claims.

What is claimed is:

1. A system for measuring a thickness of an object, the system comprising:
a conveyor to convey the object;
an engagement member movable in response to the thickness of the object;
a lever connected to the engagement member, the lever movable with the movement of the engagement member; and
a measurement device to measure the thickness of the object based on a measured movement of the lever.

2. The system of claim 1, wherein the lever is rotatable about an axis.

3. The system of claim 2, wherein the axis defines an engagement side and a free side for the lever.

4. The system of claim 3, wherein the engagement member is connected to the engagement side of the lever, and wherein the measurement device is configured to measure the position of the free side of the lever.

5. The system of claim 2, wherein the engagement member is positioned closer to the axis of the lever than the measurement device.

6. The system of claim 1, wherein the object comprises a sheet product.

7. The system of claim 1, wherein the engagement member comprises a roller configured to physically contact the object.

8. The system of claim 1, wherein the lever comprises at least one arm.

9. The system of claim 1, wherein the measurement device comprises a fiber optic unit.

10. The system of claim 9, wherein the fiber optic unit is connected to a programmable logic controller.

11. The system of claim 1, further comprising a measurement device support connected between the lever and the measurement device.

12. The system of claim 11, further comprising a deflectable member connected between the measurement device and the measurement device support such that the measurement device is deflectable with respect to the measurement device support.

13. The system of claim 1, further comprising a biasing mechanism to bias the engagement member towards the conveyor.

14. The system of claim 13, wherein the biasing mechanism comprises a spring positioned about an axis of the lever.

15. A system for measuring a thickness of an object, the system comprising:
a conveyor to convey the object;
a lever including an engagement member, the lever movable with respect to the conveyor in response to the thickness of the object;
a measurement device to measure the movement of the lever.

16. The system of claim 15, wherein the lever is rotatable about an axis, and wherein the engagement member is positioned closer to the axis of the lever than the measurement device.

17. The system of claim 15, wherein the object comprises a sheet product, wherein the engagement member comprises a roller, and wherein the measurement device comprises a fiber optic unit.

18. The system of claim 15, further comprising a biasing mechanism to bias the engagement member towards the conveyor, wherein the biasing mechanism comprises a spring positioned about an axis of the lever.

19. The system of claim 15, further comprising:
a measurement device support connected between the lever and the measurement device; and
a deflectable member connected between the measurement device and the measurement device support such that the measurement device is deflectable with respect to the measurement device support.

20. A system for measuring a thickness of a sheet product, the system comprising:
a conveyor to convey the sheet product;
a lever in proximity of the conveyor and rotatable about an axis, the axis defining an engagement side and a free side for the lever;
a roller connected to the engagement side of the lever, the roller movable with respect to the conveyor in response to the thickness of the sheet product;
a biasing mechanism to bias the roller towards the conveyor; and
a fiber optic unit to measure the position of the free side of the lever to measure the thickness of the object based on the measured position of the lever.
